(19) United States
(12) Patent Application Publication
(10) Pub. No.: US 2005/0173921 A1
(43) Pub. Date: Aug. 11, 2005

(54) Flexible header joint

(76) Inventor: Jerry Roos, Merritt (CA)

Correspondence Address: Fasken Martineau DuMoulin LLP, 2100 - 1075 West Georgia Street, Vancouver, BC, V6E 3G2, CA

(21) Appl. No.: 11/053,943

(22) Filed: Feb. 10, 2005

Related U.S. Application Data
(60) Provisional application No. 60/542,844, filed on Feb. 10, 2004.

(51) Int. Cl. F16L 27/10

(52) U.S. Cl. 285/223

(57) ABSTRACT

A flexible header joint is provided comprising a cylindrical pipe having a horizontal axis, said pipe shaped to receive a collector at a first end and an exhaust pipe at a second end; and a first spring retainer circumferentially positioned on said pipe; a cylindrical clamp positioned near said first end of said pipe, and a spring retainer circumferentially positioned on said clamp and aligned with said spring retainer on said pipe; and a spring secured to said spring retainer positioned on said pipe and said spring retainer positioned on said clamp. The flexible header joint may include at least three spring retainers circumferentially positioned on said pipe on a common plane perpendicular to said axis; at least three spring retainers circumferentially positioned on said clamp, each of said spring retainers positioned on said clamp aligned with a spring retainer positioned on said pipe; and at least three springs, a first end of each spring secured to one of said spring retainers positioned on said pipe and a second end of each spring secured to said spring retainer on said clamp aligned to said spring retainer on said pipe.

This application claims the benefit of U.S. Provisional Patent Application No. 60/542,844, filed Feb. 10, 2004, which is hereby incorporated by reference.

### NOTICE OF COPYRIGHTED MATERIAL

A portion of the disclosure of this patent document contains material that is subject to copyright protection. The copyright owner has no objection to the facsimile reproduction by anyone of the patent document or the patent disclosure as it appears in the public Patent Office file or records but otherwise reserves all copyright rights whatsoever.

1. Technical Field

This invention relates to exhaust systems in automobiles, and more particularly to joints for high performance exhaust headers.

2. Background

A common and inexpensive means of improving an automobile's performance is the addition of exhaust headers to the automobile's exhaust system. Exhaust headers improve performance of an automobile by reducing or eliminating backpressure from the exhaust system. When using exhaust headers, each cylinder in the automobile's motor uses a separate exhaust pipe (instead of sharing an exhaust pipe with other cylinders, as is conventionally done). Each of these exhaust pipes lead into a collector, which in turn leads the exhaust through an exhaust pipe to the catalytic converter and muffler.

A common problem with high performance exhaust headers is leakage of exhaust from the joint between the collector and the rest of the exhaust system. This joint also acts as a reducer as the diameter of the collector is typically larger than that of the rest of the exhaust system. It is common for this joint not to seal properly, causing the leakage. Furthermore, the seal is exposed to extremely high temperatures, frequent shaking, and movement of the engine within its mounts, further factors leading to the breakage of the seal.

Flex type exhaust joints are commonly used in production vehicles. Stock production flex joints do not adapt well to performance headers with ground clearance being an issue, as well as exhaust flow efficiency.

Related art includes U.S. Pat. No. 5,683,119 to Emmons et al., disclosing a pipe joint and seal therefor, and U.S. Pat. No. 6,164,067 to Cronje, disclosing a knuckle joint for an exhaust system.

### SUMMARY OF THE INVENTION

A flexible header joint is provided comprising a cylindrical pipe having a horizontal axis, said pipe shaped to receive a collector at a first end and an exhaust pipe at a second end; and a first spring retainer circumferentially positioned on said pipe; a cylindrical clamp positioned near said first end of said pipe, and a spring retainer circumferentially positioned on said clamp and aligned with said spring retainer on said pipe; and a spring secured to said spring retainer positioned on said pipe and said spring retainer positioned on said clamp. The flexible header joint may include at least three spring retainers circumferentially positioned on said pipe on a common plane perpendicular to said axis; at least three spring retainers circumferentially positioned on said clamp, each of said spring retainers positioned on said clamp aligned with a spring retainer positioned on said pipe; and at least three springs, a first end of each spring secured to one of said spring retainers positioned on said pipe and a second end of each spring secured to said spring retainer on said clamp aligned to said spring retainer on said pipe.

The flexible header joint may further include a spring mount clamp comprising first and second mounts; and a pinch bolt. The spring retainers positioned circumferentially on said pipe may be positioned on a first plane perpendicular to said axis and the spring retainers positioned circumferentially on said clamp may be positioned on a second plane parallel to said first plane.

### BRIEF DESCRIPTION OF FIGURES

Further objects, features and advantages of the present invention will become more readily apparent to those skilled in the art from the following description of the invention when taken in conjunction with the accompanying drawings, in which:

FIG. 1 is a side view of a flexible header joint according to the invention;

FIG. 2 is a reverse side view thereof, showing the spring retention clamp attached to the collector;

FIG. 3 is a front view of the flexible header joint according to the invention;

FIG. 4 is a perspective view thereof, and

FIG. 5 is a side view showing the flexible header joint attached to an automobile exhaust system.

### DETAILED DESCRIPTION OF PREFERRED EMBODIMENTS

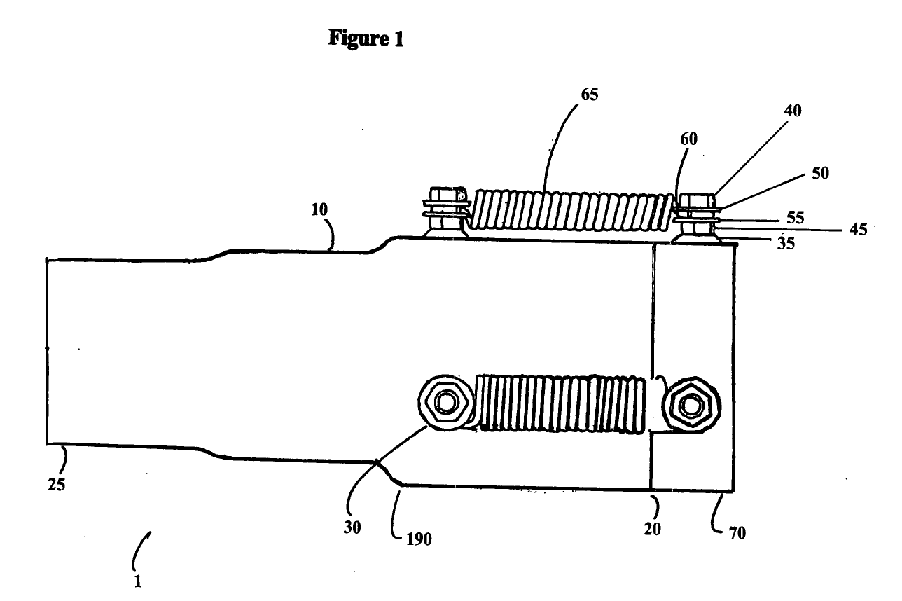

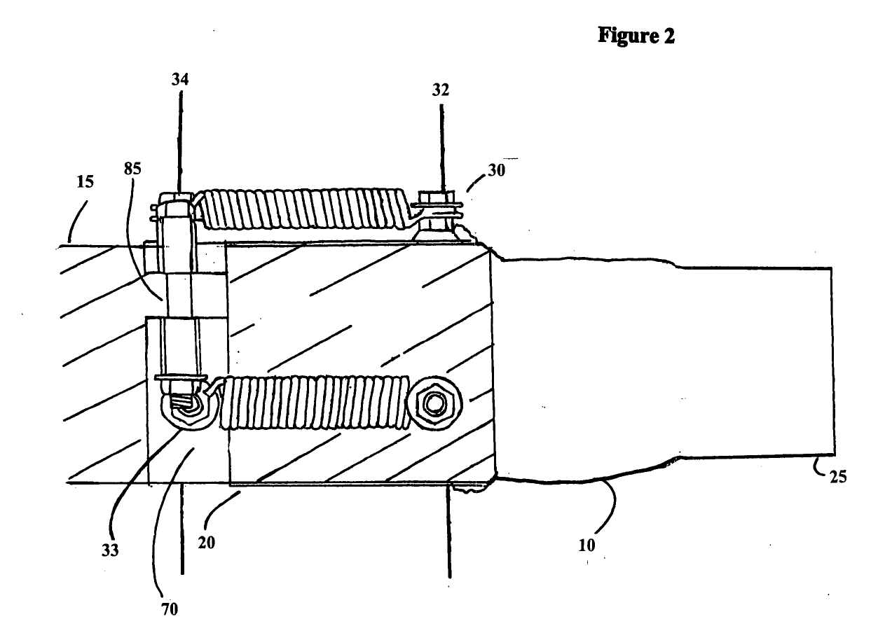

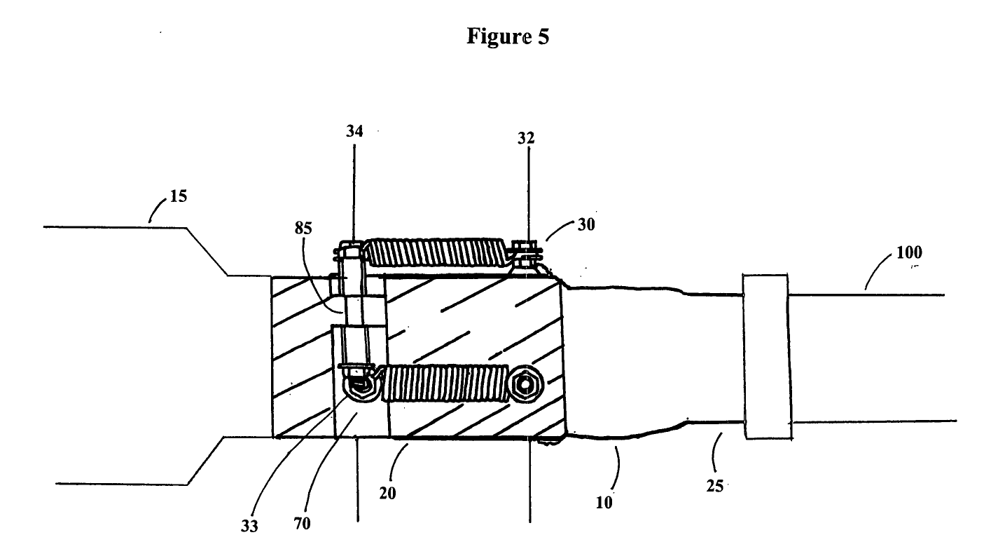

As best seen in FIGS. 1, 2 and 5, a flexible header joint 1 according to the invention comprises a cylindrical pipe 10 generally shaped to receive a collector 15 at first end 20 and an exhaust pipe 100 at second end 25. Pipe 10 preferably narrows as it approaches second end 25 from first end 20, typically in a stepped fashion. Circumferentially placed around pipe 10 is a plurality of spring retainers 30 positioned on a first plane 32 perpendicular to pipe 10. There are preferably at least three spring retainers 30 placed around pipe 10. For each spring retainer 30 on first plane 32 there is a corresponding aligned spring retainer 33 on a second plane 34. Second plane 34 is parallel to first plane 32 and perpendicular to clamp 70. Clamp 70 may be adjacent to pipe 10, but is preferably about a centimeter distant. Clamp 70 is generally cylindrical but typically defines opening 85.

Each spring retainer 30, 33 preferably comprises a base 35 welded to spring retention clamp 70 or pipe 10 as applicable; first and second nuts 40, 45; first and second washers 50, 55; and spring hook 60. Springs 65 are attached to each aligned pair of corresponding spring retainer 30, 33 thereby connecting pipe 10 with clamp 70. Other means of retaining springs are known in the art and can be used to retain springs 65, such as loops.

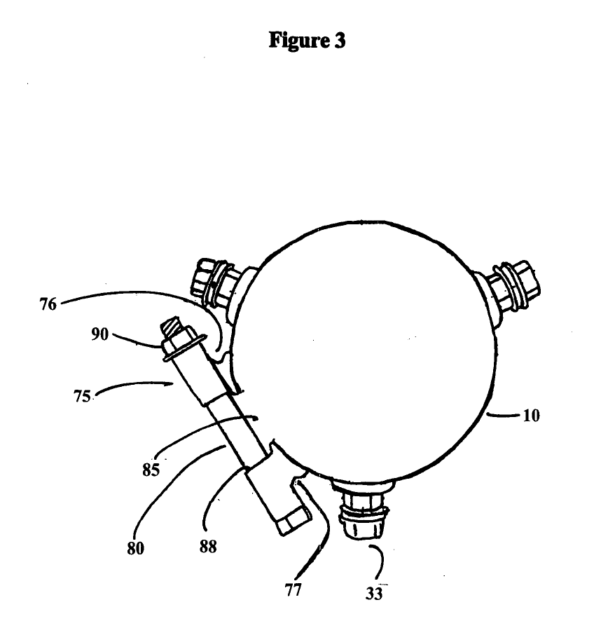

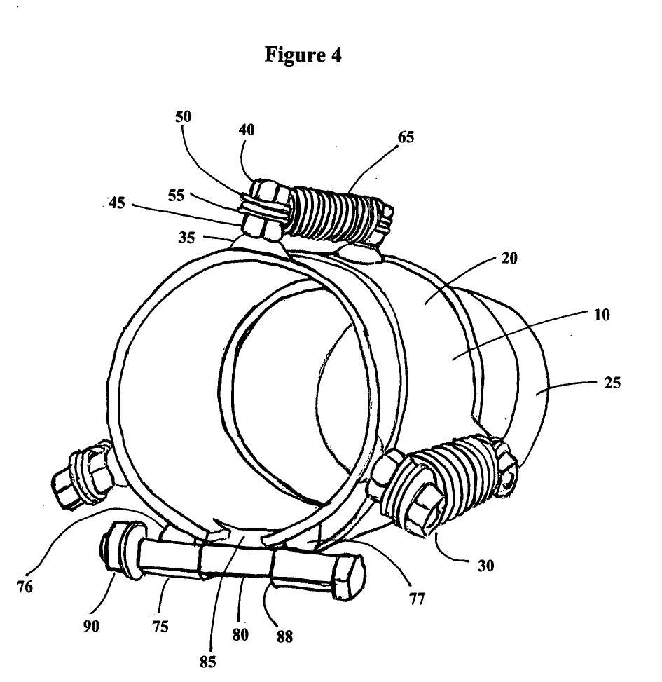

As best seen in FIGS. 3 and 4, positioned on clamp 70 is spring mount clamp 75 made up of first and second mounts 76, 77, and pinch bolt 80. Mounts 76, 77 each have aperture 88 to receive bolt 80. At one end of bolt 80 is a nut 90. Nut 90 can be tightened to secure clamp 70 to collector 15.

In operation springs 65 allow clamp 70 to move horizontally, i.e. the distance between clamp 70 and pipe 10 can vary without cracking or damaging joint 1. Likewise, springs 65 allow clamp 70 to rotate or twist relative to pipe 10 without leakage or damage to the joint. This permitted movement, both horizontally and rotationally, provides the flexibility necessary to reduce or eliminate breakage and leakage of the joint. The flexible header joint 1, properly used, can therefore withstand large amounts of heat and forces produced by the exhaust system and motion of the engine within its mount and the automobile.

To install the flexible header joint 1 the collector 15 is preferably at least a minimum length (typically about 4.5″ inches) so that clamp 70 can be used effectively. If collector 15 is too short, the spring retainers 33 can be welded directly to the header, and clamp 70 need not be used. Alternatively, the collector 15 can be lengthened prior to installation.

Any previously installed header collectors should be removed from the existing exhaust system and the exhaust pipes should be stored out of the way. The sealing flange should be removed from the collector to leave as much length as possible in the collector. Preferably the end of collector 15 is as close as possible to being square shaped to aid in the initial sealing with the flexible header joint 1. Then tension springs 65 are then unattached from clamp 70. Clamp 70 and as much of the flexible header joint 1 as possible is then slid onto collector 15 until the end of collector 15 contacts sealing surface 190 (this can be done with tools as simple as a hammer and a block of wood placed on the end of the flexible header joint). Clamp 70 is then slid to a position typically about ½″-¼″ from the pipe 10. Clamp 70 is then tightened by tightening spring mount clamp 75 (it should not be over tightened as doing so may damage collector 15). Springs 65 are then reattached to clamp 70 by using the nuts 40, 45, washers 50, 55, and spring hook 60 in the appropriate order. To position springs 65 a tool such as a small vice grip may be used. Spring hook 60 is grasped tightly and pulled to spring retainer 30. The exhaust pipes are then reattached using the stepped section of the flexible header joint 1. The exhaust pipe may be cut to the appropriate length and either welded or clamped to the flexible header joint 1.

While the principles of the invention have now been made clear in the illustrated embodiments, it will be immediately obvious to those skilled in the art that many modifications may be made of structure, arrangements, and algorithms used in the practice of the invention, and otherwise, which are particularly adapted for specific environments and operational requirements, without departing from those principles. The claims are therefore intended to cover and embrace such modifications within the limits only of the true spirit and scope of the invention.

1. A flexible header joint comprising:
(a) a cylindrical pipe having a horizontal axis, said pipe shaped to receive a collector at a first end and an exhaust pipe at a second end; and a first spring retainer circumferentially positioned on said pipe;
(b) a cylindrical clamp positioned near said first end of said pipe, and a spring retainer circumferentially positioned on said clamp and aligned with said spring retainer on said pipe; and
(c) a spring secured to said spring retainer positioned on said pipe and said spring retainer positioned on said clamp.

2. The flexible header joint of claim 1 further comprising:
at least three spring retainers circumferentially positioned on said pipe on a common plane perpendicular to said axis;
at least three spring retainers circumferentially positioned on said clamp, each of said spring retainers positioned on said clamp and aligned with a spring retainer positioned on said pipe; and
at least three springs, a first end of each spring secured to one of said spring retainers positioned on said pipe and a second end of each spring secured to said spring retainer on said clamp aligned to said spring retainer on said pipe.

3. The flexible header joint of claim 2 further comprising a spring mount clamp.

4. The flexible header joint of claim 3 wherein said spring mount clamp comprises:
(a) first and second mounts; and
(b) a pinch bolt.

5. The flexible header joint of claim 4 wherein said spring retainers positioned circumferentially on said pipe are positioned on a first plane perpendicular to said axis.

6. The flexible header joint of claim 5 wherein said spring retainers positioned circumferentially on said clamp are positioned on a second plane parallel to said first plane.

7. The flexible header joint of claim 6 wherein said pipe narrows from said first end to said second end in a stepped fashion.
